(19) United States
(12) Patent Application Publication
(10) Pub. No.: US 2026/0195021 A1
(43) Pub. Date: Jul. 9, 2026

(54) CONTROLLING OPERATIONAL FUNCTIONS OF PHYSICAL ELECTRONIC DEVICE THROUGH INTERACTIONS IN VIRTUAL SPACE OF EXTENDED REALITY ENVIRONMENT

(71) Applicant: Telefonaktiebolaget LM Ericsson (publ), Stockholm (SE)

(72) Inventors: Tommy ARNGREN, SÖDRA SUNDERBYN (SE); Peter ÖKVIST, LULEÅ (SE); Niklas LINDSKOG, LUND (SE)

(73) Assignee: Telefonaktiebolaget LM Ericsson (publ), Stockholm (SE)

(21) Appl. No.: 19/134,273

(22) PCT Filed: Dec. 2, 2022
(86) PCT No.: PCT/EP2022/084185

§ 371 Date: May 30, 2025

(51) Int. Cl. G06F 3/04815; G06F 3/01; G06F 3/0482; G06F 21/62; G06T 19/00

(52) U.S. Cl. CPC G06F 3/04815; G06F 3/0482; G06F 21/629; G06T 19/006; G06F 3/011; G06T 2200/24; G06T 2219/024

(57) ABSTRACT

An XR rendering device performs operations to define a virtual portal with an entrance boundary at a location in physical space of a first participant. The operations track a location of a physical object relative to the location of the entrance boundary. The operations render a virtual electronic device representation in the immersive XR environment of at least a portion of the physical electronic device responsive to determining the physical electronic device has entered the virtual portal. The rendering of the virtual electronic device includes a virtual user interface that a second participant can interact with in the immersive XR environment. The operations identify a characteristic of an interaction of the second participant with the virtual user interface. The operations also communicate with the physical electronic device to control an operational function of the physical electronic device based on the identified characteristic of the interaction.

### TECHNICAL FIELD

The present disclosure relates to rendering extended reality (XR) environments and associated XR rendering devices, and more particularly to rendering objects in immersive XR environments for display on XR participant devices.

### BACKGROUND

Immersive extended reality (XR) environments have been developed which provide a myriad of different types of user experiences for gaming, on-line meetings, co-creation of products, etc. One type of immersive XR environments (also referred to as “XR environments”) is virtual reality (VR) environments where human users only see computer generated graphical renderings. Another type of XR environment is augmented reality (AR) environments where users see a combination of computer-generated graphical renderings overlaid on a view of the physical real-world through, e.g., see-through display screens.

Example XR environment rendering devices include, without limitation, XR environment servers, XR headsets, gaming consoles, smartphones running an XR application, and tablet/laptop/desktop computers running an XR application. Oculus Quest is an example VR device with AR functionality and Google Glass is an example AR device.

XR meeting applications are tools for experiencing online immersive meetings and are useful as a thinking and planning space for oneself as well as among a group of people. Some XR meeting applications support AR devices, browsers, and VR devices. A participant using a browser may join via desktop, tablet-PC or smartphone and share their views using a front faced cam or a web cam. Some XR meeting solutions have mobile application versions, e.g., Android and iOS, which allow a user to navigate in the virtual space on the screen or activate an AR mode to display the meeting in their own surroundings. The XR meeting solutions introduce new features to online meetings that allow for new ways to share and create content etc. Today's commonly and commercially available XR devices typically include a head-mounted device (HMD) and a pair of hand controllers, sometimes with more advanced solutions including “foot controllers”.

Immersive XR environments, such as gaming environments and meeting environments, are often configured to display computer generated avatars which represent poses of human users in the immersive XR environments. A user may select and customize an avatar, such as gender, clothing, hair style, etc. to represent that user for viewing by other users participating in the immersive XR environment. Users can interact with virtual objects that are rendered in the immersive XR environment, such as by controlling their avatars to manipulate virtual objects. Immersive XR environments presently support little if any interface between physical objects and virtual objects that are rendered.

### SUMMARY

Some embodiments disclosed herein are directed to an XR rendering device for rendering an immersive XR environment on a display device for viewing by a second participant in the immersive XR environment. The XR rendering device includes processing circuitry adapted to perform operations. The operations include to define a virtual portal with an entrance boundary at a location in physical space of a first participant. The operations track a location of a physical object relative to the location of the entrance boundary. The operations render a virtual electronic device representation in the immersive XR environment of at least a portion of the physical electronic device responsive to determining the physical electronic device has entered the virtual portal. The rendering of the virtual electronic device includes a virtual user interface that the second participant can interact with in the immersive XR environment. The operations identify a characteristic of an interaction of the second participant with the virtual user interface of the virtual electronic device. The operations also communicate with the physical electronic device to control an operational function of the physical electronic device based on the identified characteristic of the interaction.

Some other embodiments are directed to a corresponding method by an XR rendering device for rendering an immersive XR environment on a display device for viewing by a second participant in the immersive XR environment. The method includes defining a virtual portal with an entrance boundary at a location in physical space of a first participant and second participant. The method also includes tracking a location of a physical object relative to the location of the entrance boundary. The method also includes rendering a virtual electronic device representation in the immersive XR environment of at least a portion of the physical electronic device responsive to determining the physical electronic device has entered the virtual portal. The rendering of the virtual electronic device includes a virtual user interface that the second participant can interact with in the immersive XR environment. The method also includes identifying a characteristic of an interaction of the second participant with the virtual user interface of the virtual electronic device. The method also includes communicating with the physical electronic device to control an operational function of the physical electronic device based on the identified characteristic of the interaction.

Some other embodiments are directed to a corresponding computer program product including a non-transitory computer readable medium storing instructions executable by at least one processor of XR rendering device rendering an immersive XR environment on a display device for viewing by a second participant in the immersive XR environment. The instructions executed by the at least one processor perform operations including defining a virtual portal with an entrance boundary at a location in physical space of a first participant. The instructions also include tracking a location of a physical object relative to the location of the entrance boundary. The instructions also include rendering a virtual electronic device representation in the immersive XR environment of at least a portion of the physical electronic device responsive to determining the physical electronic device has entered the virtual portal. The rendering of the virtual electronic device includes a virtual user interface that the second participant can interact with in the immersive XR environment. The instructions also include identifying a characteristic of an interaction of the second participant with the virtual user interface of the virtual electronic device. The instructions also include communicating with the physical electronic device to control an operational function of the physical electronic device based on the identified characteristic of the interaction.

Some potential advantages of these embodiments are that they allow the first participant (sending participant) in an immersive XR environment to enable a physical electronic device to become rendered as a virtual object by the first participant passing the physical object through the location of the virtual portal in physical space. The second participant can interact with a user interface of the rendered virtual object in the immersive XR environment to control an operational function of the physical electronic device. Through these and other embodiments the usual boundary between physical and virtual space can become intuitively crossed by participants in the immersive XR environment. Moreover, for example, the first participant can use the virtual portal to share a user interface of a smart phone with the second participant, and can allow the second participant to control various operational functionality of the smart phone through interactions with the virtual user interface representation in the immersive XR environment.

Other XR rendering devices, methods, and computer program products according to embodiments will be or become apparent to one with skill in the art upon review of the following drawings and detailed description. It is intended that all such additional XR rendering devices, methods, and computer program products be included within this description and protected by the accompanying claims.

### BRIEF DESCRIPTION OF THE DRAWINGS

Aspects of the present disclosure are illustrated by way of example and are not limited by the accompanying drawings. In the drawings:

FIG. 1 illustrates an XR system that includes a physical electronic device and a plurality of participant devices that communicate through networks with an XR rendering device to operate in accordance with some embodiments of the present disclosure;

FIG. 2 is an example illustration of the XR rendering device tracking location of a physical object in the first participant's physical space while the physical object is being passed through a virtual portal and being rendered in the virtual space of the immersive XR environment, in accordance with some embodiments of the present disclosure;

FIG. 3 illustrates an alternative example operation of the XR rendering device of FIG. 2 with a virtual user interface being projected from the virtual electronic device in the virtual space of the immersive XR environment, in accordance with some embodiments of the present disclosure;

FIG. 4 illustrates an example virtual portal with a virtual user interface (UI) displaying the content of the UI of a physical smartphone, in accordance with some embodiments of the present disclosure;

FIG. 5 is a flowchart of operations that can be performed by an XR rendering device in accordance with some embodiments of the present disclosure;

FIG. 6 is a block diagram of components of an XR rendering device that are configured to operate in accordance with some embodiments of the present disclosure; and

FIG. 7 is a block diagram of components of an electronic device that are configured to operate in accordance with some embodiments of the present disclosure.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of various present inventive concepts to those skilled in the art. It should also be noted that these embodiments are not mutually exclusive. Components from one embodiment may be tacitly assumed to be present/used in another embodiment.

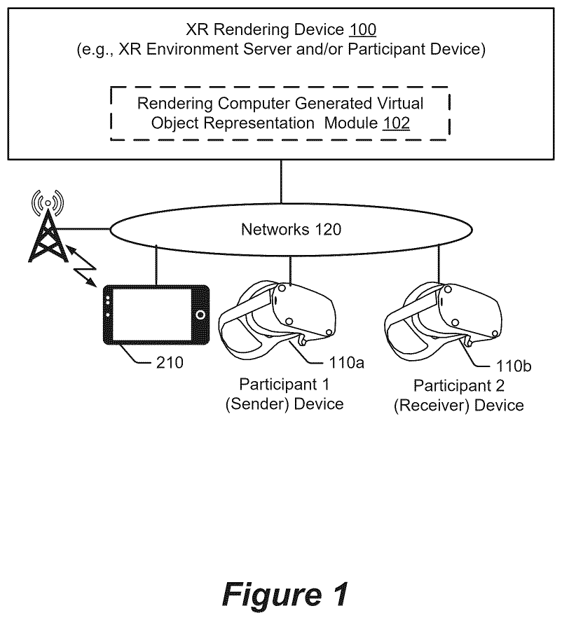

FIG. 1 illustrates an XR system that includes a physical electronic device 210 and a plurality of participant devices 110a and 110b that communicate through networks 120 with an XR rendering device 100 to operate in accordance with some embodiments of the present disclosure. The XR rendering device 100 is configured to generate a graphical representation of an immersive XR environment (also called an “XR environment” for brevity) with a rendering computer generated virtual object representation module 102 which is viewable from various perspectives of virtual poses of human participants in the XR environment through display screens of the various participant devices 110a-b and/or a physical electronic device 210.

For example, the illustrated devices of FIG. 1 include XR headsets 110a and 110b which can be worn by participants to view and navigate through the XR environment. The participant devices are not limited to XR headsets, as they could be a personal computer, tablet computers, smart phone, or other electronic device which can be operated by a participant to view and navigate through the XR environment. The participants may have associated avatars which are rendered in the XR environment to represent poses (e.g., location, body assembly orientation, etc.) of the participants relative to a coordinate system of the XR environment.

A physical electronic device 210, also called “physical object” and “electronic device,” has electronic operation(s) which can be controlled through a user interface. The physical electronic device 210 can be any type of electronic device that has a user interface. Non-limiting examples of physical electronic devices include smart phones, personal computers, table computers, smart appliances, etc. Non-limiting examples of user interfaces include touch screens and other display devices that can display user selectable indicia and/or user selectable menus, and physical buttons, touch sensor interfaces, etc.

As will be explained in further detail below, a representation of the physical electronic device 210 is rendered in the XR environment as a virtual electronic device with a virtual representation of a user interface of the physical electronic device 210. A participant in the XR environment can interact with the virtual user interface in order to control various electronic operational function(s) of the physical electronic device 210.

Although the XR rendering device 100 is illustrated in FIG. 1 as being a centralized network computing server separate from one or more of the participant devices, in some other embodiments the XR rendering device 100 is implemented as a component of one or more of the participant devices. For example, one of the participant devices may be configured to perform operations of the XR rendering device in a centralized manner controlling rendering for or by other ones of the participant devices. Alternatively, each of the participant devices may be configured to perform at least some of the operations of the XR rendering device in a distributed decentralized manner with coordinated communications being performed between the distributed XR rendering devices (e.g., between software instances of XR rendering devices).

Some embodiments of the present disclosure are directed to an XR rendering device enabling one or more participants in an immersive XR environment to pass a physical electronic device through one or more virtual portals located in physical space, to trigger the XR rendering device 100 to render a virtual electronic device representing the physical object in the immersive XR environment. In an illustrative example, a first participant may reach a physical electronic device such as a smartphone through the virtual portal to trigger to the XR rendering device 100 to render a computer-generated virtual representation of the smartphone in the immersive XR environment. The first participant and another second participant may simultaneously view the virtual smartphone. The second participant may similarly reach a another smartphone through a virtual portal to trigger rendering of another virtual smartphone and interact with the virtual smartphone of the first participant. The first and second participant may be provided corresponding feedback of the virtual interaction with the virtual smartphone, e.g., as tactile feedback initiated by the XR rendering device 100 and provided through a tactile device, such as gloves or smart fabric, worn by the first and second participants. As will be appreciated in view of the description provided below, the type of physical object that can be passed through a virtual portal for rendering and possible interaction with by participants in the immersive XR environment is not limited by any of the operational embodiments herein.

In accordance with various further embodiments of the present disclosure, responsive to determining the smartphone has entered the virtual portal, operations render a virtual electronic device representation in the immersive XR environment of at least a portion of the smartphone, where the rendering of the virtual electronic device include a virtual user interface that the other participant can interact with in the immersive XR environment. The operations identify a characteristic of an interaction of the other participant with the virtual user interface of the virtual electronic device, and communicate with the smartphone to control an operational function of the smartphone based on the identified characteristic of the interaction.

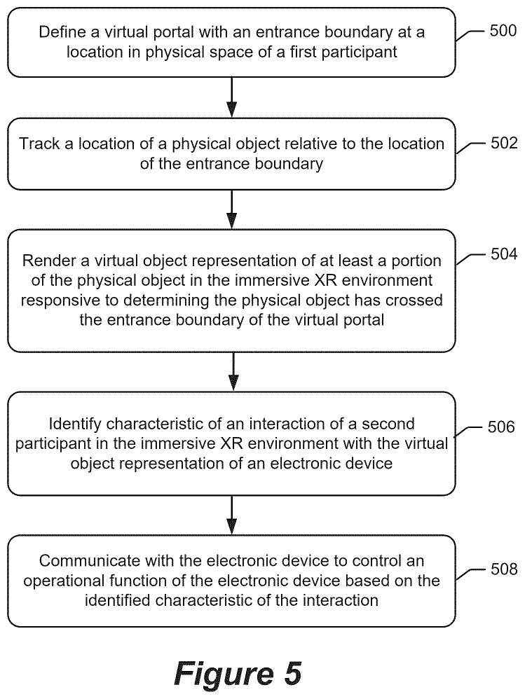

FIG. 5 is a flowchart of operations that can be performed by an XR rendering device in accordance with some embodiments of the present disclosure.

Referring to FIGS. 1 and 5, an XR rendering device 100 is provided for rendering an immersive XR environment on a display device for viewing by a participant among a group of participants in the immersive XR environment. The XR rendering device includes processing circuitry adapted to perform operations. The operations include to define 500 a virtual portal with an entrance boundary at a location in physical space of a first participant. The operations track 502 a location of a physical object relative to the location of the entrance boundary. The operations render 504 a virtual electronic device representation in the immersive XR environment of at least a portion of the physical electronic device 210, where the rendering of the virtual electronic device includes a virtual user interface that a second participant can interact with in the immersive XR environment responsive to determining the physical electronic device 210 has entered the virtual portal. The operations identify 506 a characteristic of an interaction or participant with the virtual user interface of the virtual electronic device. The operations also communicate 508 with the physical electronic device 210 to control an operational function of the physical electronic device 210 based on the identified characteristic of the interaction.

The XR rendering device 100 may be a single computing device or may be a distributed system of computing devices, e.g., computer servers, connected via one or more networks, such as a cloud computing environment. A non-limiting example of a XR rendering device is the cloud computing environment provided by Oculus which includes numerous networked computing devices which host VR gaming environments serving Oculus VR headsets worn by remote users.

The second participant can interact with the virtual user interface in the immersive XR environment by controlling an avatar representing the second participant, or hands of the second participant interacting with the virtual electronic device. The second participant may additionally or alternatively interact with the virtual user interface through the computer tracking of the second participant's physical hand interacting with the virtual user interface of the virtual electronic device.

The rendering of the virtual object may be provided to a device of the participant and/or one or more other participants for viewing and possible interaction with. XR headsets can be worn by participants in the immersive XR environment to provide an intuitive way for the participants to view the rendered virtual object and possibly also view a rendering of the virtual portal.

Some potential advantages of these embodiments are that they enable participants in virtual meetings to control operational function(s) of physical electronic devices in virtual portal by interacting with a virtual user interface in the XR environment. As will be explained in further detail below, what operational function(s) and interactions are allowed to be controlled and/or interacted with may be constrained by access rules and/or recipient-sender trust relations.

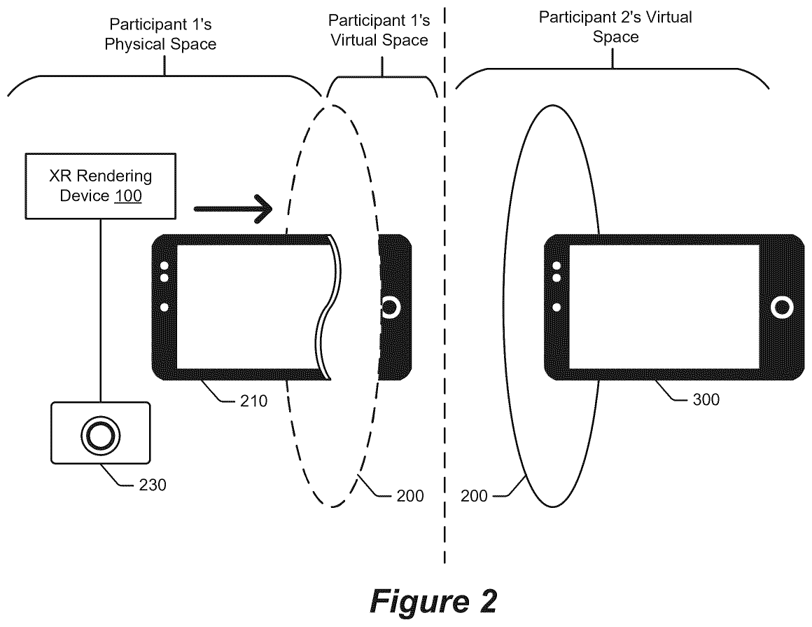

FIG. 2 is an example illustration of the XR rendering device 100 tracking location of a physical electronic device 210 in the first participant's physical space while the physical electronic device 210 is being passed through a virtual portal 200 and rendered in the virtual space of the immersive XR environment, in accordance with some embodiments of the present disclosure. Referring to FIG. 2, Participant 1 and Participant 2 are present participants in an immersive XR environment rendered by the XR rendering device 100. Participant 1 and Participant 2 can simultaneously view virtual objects that are rendered by the XR rendering device 100 in their respective virtual spaces, such as through XR headsets worn by the participants. The XR rendering device 100 is communicatively coupled to at least one sensor 230 that tracks location of a physical electronic device 210, e.g., a smart phone, relative to the boundary of a virtual portal 200 having a location defined in physical space. The sensor 230 may be one or more cameras mounted to an XR headset and facing forward in the wearer's eye gaze direction. The sensor 230 may additionally or alternatively be other types of sensors able to track location of physical objects, such as LIDAR sensors, ultrasound sensors, etc. In some embodiments, two cameras may be used to track location of the physical electronic device 210 in three-dimensional (3D) space or a single LIDAR sensor may be used. LIDAR and one or more cameras may be used together to track and determine location, shape, texture, temperature, tactile notification, and color of the physical electronic device 210. Alternatively or additionally, the XR headset or other device transported by a participant may contain a sensor(s) that can track pose, such as an inertial measurement unit, and report the pose (e.g., location, head orientation, etc.) to the XR rendering device 100.

In some embodiments, the XR rendering device 100 defines a location, size, and shape of an entrance boundary of virtual portal 200. The location of the entrance boundary of virtual portal 200 is defined in physical space, such as relative to a feature on a physical table in a room, a distance away from Participant 1, relative to an object worn by Participant 1 (smartwatch, smart glasses, etc.), etc. A computer generated representation of the virtual portal 200 may be displayed in the immersive XR environment in the virtual space viewed by Participant 1. The computer generated representation of the virtual portal 200 may additionally or alternatively be displayed in the in the virtual space viewed by Participant 2, such as when Participants 1 and 2 are sharing an immersive XR environment.

The term virtual space is used herein to refer to the displayable space within the computer rendered immersive XR environment. In contrast, physical space is used to refer to the real space in which the human participant resides.

In some embodiments, the XR rendering device 100 defines a location of an entrance boundary of the virtual portal 200 relative to a reference system in physical space where the participant resides and which is tracked by one or more sensors 230. The entrance boundary may be a single point, may extend along a two-dimensional (2D) plane (e.g., flat rectangle or flat circle), such as illustrated in FIG. 2, or may be a three-dimensional (3D) shape (e.g., sphere or box). The entrance boundary may be defined to be a fixed distance and/or a fixed angle (fixed pose offset) relative to the participant or relative to a defined physical object which is in the physical space. The participant and/or the defined physical object may move within the physical space, and the entrance boundary location in the reference system of physical space may be dynamically updated to track changes in location of the participant and/or the defined physical electronic device 210.

In some embodiments, the physical object includes an electronic device having operational functionality that is controllable by a user interface. The operations identify a characteristic of an interaction of the second participant, e.g., via an avatar representing the second participant, in the immersive XR environment with the virtual user interface of the virtual electronic device. The operations communicate with the electronic device to control an operational function of the electronic device based on the identified characteristic of the interaction.

Some further embodiments are now described in the context of the example above where Participant 1 has passed a physical smartphone across the entrance boundary of the virtual portal, which has triggered the XR rendering device to render a virtual smartphone in the immersive XR environment to be viewable by Participants 1 and 2 through their respective XR headsets.

In one of these further embodiments, the XR rendering device tracks interaction of Participant 2's avatar with the virtual smartphone and may change the rendered pose of the virtual smartphone responsive to Participant 2's interaction. For example, the XR rendering device may rotate the virtual smartphone to track movement of Participant 2 avatar's hand rotating while virtually holding the virtual smartphone. In this manner, Participant 2 can rotate the virtual smartphone to view other surfaces thereof, and Participant 1 can visually observe Participant 2's interaction with the virtual smartphone.

In another of these further embodiments, the XR rendering device tracks interaction of Participant 2's avatar with the virtual smartphone and provides feedback to Participant 1 to responsively change pose of the physical smartphone which, in turn, will then change the rendered pose of the virtual smartphone. For example, the XR rendering device may track movement of Participant 2 avatar's which is posed to virtually hold the virtual smartphone, and provide visual feedback, audible feedback, and/or tactile feedback to guide Participant 1 to change pose of the physical smartphone in a manner that corresponds to the determined movement of Participant 2 avatar's hand. As Participant 1 change pose, e.g., rotates, the physical smartphone, the XR rendering device can track the observed movements to render updated poses of the virtual smartphone.

In an example, Participant 1 lets Participant 2 use the Participant 1's smartphone represented as a virtual smartphone in the XR environment to send a message to someone. Participant 1 pushes a physical smartphone through the virtual portal, which triggers rendering of a virtual smartphone in the XR environment, and rendering of a virtual representation of a user interface (UI) for the physical smartphone in the XR environment. Participant 2 interacts with the virtual user interface displayed on (or associated with, e.g., adjacent to) the virtual smartphone to, e.g., select a text message icon and enter (type-in, speech input, etc.) a message destination address (Participant 3 or other person with device having messaging capability) and message content. The message destination address and message content are communicated from the XR rendering device (XR server) to the physical smartphone and passed to a messaging application to trigger creation of a message directed to the message destination address (Participant 3) and containing the message content. Participant 2 may further interact with the user interface displayed on the virtual smartphone to trigger sending of the created message by the physical smartphone to the message destination address.

In another example, a user, also called “participant,” needs help from an online help center for operation of a smartphone. The user (participant) pushes the physical smartphone through the virtual portal, which triggers rendering of the virtual smartphone in an XR help center environment which includes a help center participant. A help center participant interacts with a virtual representation of a user interface displayed on (or associated with) the virtual smartphone. In one example, the help center participant selects a “Settings” icon displayed in the XR environment, which triggers communication of that selection to the physical smartphone and passed to the operating system (OS) to cause display of Settings sub-menu items on the physical smartphone and corresponding rendering of a representation of the Settings sub-menu items on or adjacent to the virtual smartphone in the XR environment. The help center participant can further select among the rendered hierarchy of displayed sub-menu items and/or set operational modes and/or values through the rendered user interface of the virtual smartphone to cause communication of corresponding selections and/or set operational modes and/or values to the physical smartphone and corresponding control operation of the physical smartphone.

In examples with interaction with a virtual electronic device through the virtual portal, this can be understood as the second participant being allowed to physically interact with the digital representation of the physical electronic device, and thereby digitally interact with the virtual electronic device. For example, the second participant may use their hand to touch the location the virtual electronic device is projected on their XR rendering device. The interaction may be of such nature that any internal states are changed and, if so, said interactions may be notified to first participant for manual or explicit acknowledgement or non-acknowledge. The interactions may be selectively allowed subject to per-recipient default rules, etc. The second participant may be allowed to change state of physical electronic device directly. These aspects will be described in further embodiments.

In some embodiments, the virtual user interface is rendered to display to the second participant a first set of user selectable items that corresponds to a second set of user selectable items that are displayed on a display of the physical electronic device 210, and the identified characteristic indicates one of the user selectable items in the first set that has been selected by the second participant, e.g., through an avatar.

In some of these embodiments, the communication with the physical electronic device 210 identifies the one of the user selectable items in the first set to trigger control of the operational function of the physical electronic device 210 that is associated with one of the user selectable items in the second set that corresponds to the one of the user selectable items in the first set.

In some embodiments, the rendering of the virtual user interface includes an arrangement of graphical objects that are selectable by the second participant, e.g., by an avatar, in the immersive XR environment and/or arrangement of menu items that are selectable by the second participant in the immersive XR environment.

Graphical objects may be icons or any virtual object which the participant is able to press or interact with.

Once the physical object has passed the portal and is represented as a digital object, the digital representation of the physical object is unlocked for the second (receiving) user. Assuming that the physical object has operational features which can be represented by the digital representation of the physical object, how the second participant may access, activate, or modify these operational features may be controlled (governed) by a policy.

The virtual electronic device may be associated with a policy that includes an authorization part and a persistence part. The authorization part defines what features of the physical electronic device the second participant is allowed to utilize, e.g. apps, settings, features, interfaces, files etc., and how changes to such features should be transferred to the physical electronic device. The persistence part defines what happens to the features when the electronic device is no longer present in the virtual portal, e.g., do the features stay updated or revert to an operational state prior to the electronic device becoming present in the virtual portal

The policy may be defined by the user beforehand and may be associated with the second participant, e.g. “when I share my device with Tommy, he may access apps A, B, C”. The policy may also be decided ad hoc during the sharing, e.g. by issuing a voice comment “allow Tommy to access apps A, B, C.”

Each feature may have its own specified access rules, where the attributes in these access rules includes, but are not limited to, read, write, delete, export, import, on-behalf-of.

The picture gallery may allow the second participant to look at the pictures (read) and to send the pictures to an external device (export). The second participant is however not allowed to change (write), add (import) or delete any pictures from the gallery.

On-behalf-of controls if the second participant is allowed to utilize the first participant's profile and configured accounts when using features, i.e. should a mail application login to the first participant mailbox or prompt a login screen.

In some embodiments, the operations further include to control what interaction the second participant is permitted to have with the virtual user interface of the virtual electronic device based on a security mechanism.

In some embodiments, the security mechanism defines functions of the physical electronic device 210 the second participant is allowed to control through interactions by the second participant with the virtual user interface.

For example, the second participant may interact with the virtual user interface through tracked motion of their hand, a stylus, a touch-pen, or by controlling an avatar representation of the second participant in the immersive XR environment.

In some embodiments, the security mechanism defines which items of the virtual user interface are selectable by the second participant in the immersive XR environment, e.g., through the avatar.

In some embodiments the operations also include to render the virtual user interface to display items that the security mechanism defines as being selectable by the second participant with a different visual indication than other items that the security mechanism defines as being not selectable by the second participant or to not display items that the security mechanism defines as being not selectable by the second participant.

The XR rendering device (XR server) may be controlled based on one or more access rules as to which of the displayed virtual UI elements are selectable by Participant 2 or other participants in the immersive XR environment. The access rule(s) may define which identified persons are permitted to select which virtual UI elements or otherwise access defined operational functions of the physical electronic device. For example, Participant 2 may have different access privileges than another participant for selecting virtual UI element(s) and/or accessing defined operational functions of the physical electronic device. Virtual UI elements which are permitted by the access rule(s) to be selected by Participant 2 may be displayed in a visually different way (e.g., color, shading, font, etc.) than other virtual UI elements which are not permitted by the access rule(s) to be selected by Participant 2. The access rules may be visualized by grayed out options, or by something indicating the allowed actions to the second participant. Upon second participant pressing a grayed-out (not-yet approved option), managing application may fetch that under-leveled option interaction and provide first participant with an option to either allow or deny said interaction request.

The persistence part on the other hand defines how the actions on the virtual electronic device will affect the real device and in what way. Options include temporary/permanent, per action/end of session, automatic/manual approval. For example, when the above-example physical smartphone is withdrawn from the virtual portal, the XR rendering device (XR server) and/or an application on the physical smartphone (physical electronic device) can operate to return the physical smartphone to its initial operational state existing immediately before entering the virtual portal. In one embodiment, a journal of operations is created which logs a sequence of operations that are performed on the physical smartphone and/or changes in operational state(s) of the physical smartphone while it is within the virtual portal, e.g., responsive to participant(s) in the XR environment manipulating the virtual UI. In response to the physical smartphone being withdrawn from the virtual portal, the sequence of operations and/or operational state(s) logged in the journal can be operationally undone, e.g., reversed, to return the physical smartphone to its initial operational state existing immediately before entering the virtual portal.

In some embodiments, the operations also include to determine the security mechanism based on at least one of:
a characteristic of the operational function of the electronic device attempted to be controlled by the second participant;
an identifier of the second participant;
a proof of possession of a digital token or cryptographic key of the second participant, or secret token;
a location of the first participant;
a location of the second participant;
a time of day or day of week, such as only being available on weekdays;
a set of capabilities requested from the interaction of the second participant
a characteristic of the location of the first participant; and
a characteristic of the location of the second participant.

If the physical electronic device should be unaffected by the sharing, a temporary digital representation of the physical device (virtual electronic device) may be created, and any changes made will be deleted when the physical electronic device exits the portal.

In some embodiments, the operations also include to restore the physical electronic device 210 to an operational state existing prior to when the physical electronic device 210 entered the virtual portal responsive to the physical electronic device 210 being removed from the virtual portal.

In some embodiments, the operations also include to backup content of a portion of the at least one memory responsive to determining the physical electronic device 210 has entered the virtual portal. The operations further include to restore the portion of the at least one memory based on the backup based on the physical electronic device 210 being removed from the virtual portal.

In some embodiments, the operations also include to generate a queue containing a sequence of identified characteristics of interactions of the avatar with the virtual user interface of the virtual electronic device while the physical electronic device 210 remains in the virtual portal. The operations further include to communicate the sequence of identified characteristics of the interactions contained in the queue to the physical electronic device 210 to control corresponding operational functions of the physical electronic device 210, e.g., responsive to the physical electronic device 210 being removed from the virtual portal. Alternatively or additionally, the queue may be generated and used at any time, e.g., generated while the physical electronic device 210 is outside the virtual portal and then used to control operation of the physical electronic device 210 while within the virtual portal.

In some embodiments, the operations also include to terminate rendering of the virtual electronic device representation in the immersive XR environment, including terminating the rendering of the virtual user interface responsive to the physical electronic device 210 being removed from the virtual portal.

If the physical electronic device should be changed on the other hand, the XR rendering device must store actions, e.g., operational inputs and/or changes, and transfer them to the physical electronic device. This can be performed in a direct manner, i.e., that each action is directly applied to the physical electronic device, keeping the physical electronic device and the virtual electronic device in sync. It is also possible to perform a bulk transfer of the changes when the physical electronic device exits the portal.

The permanence of the action may be chosen manually by the participant or automatically, either for each feature or for the physical electronic device as a whole.

Access rules may be context and geo-based; depending on location of second participant, for example at home, in some trusted environment, or at public location, relation to users in a defined vicinity of the second participant, and depending on private, business context. Some applications and/or content may have different access rules applied.

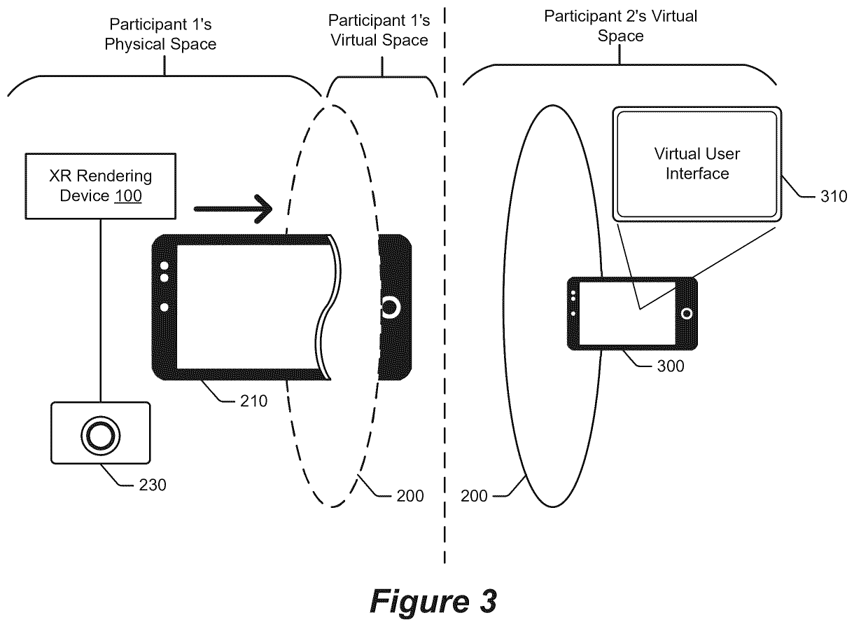

FIG. 3 illustrates an alternative example operation of the XR rendering device of FIG. 2 with a virtual user interface 310 being projected from the virtual electronic device in the virtual space of the immersive XR environment, in accordance with some embodiments of the present disclosure. Participant 2 can interact with the virtual user interface 310 in the immersive XR environment by, for example, controlling a hand of an avatar or using a real hand that is tracked in 3D space of the immersive XR environment via a camera or other position tracking sensor.

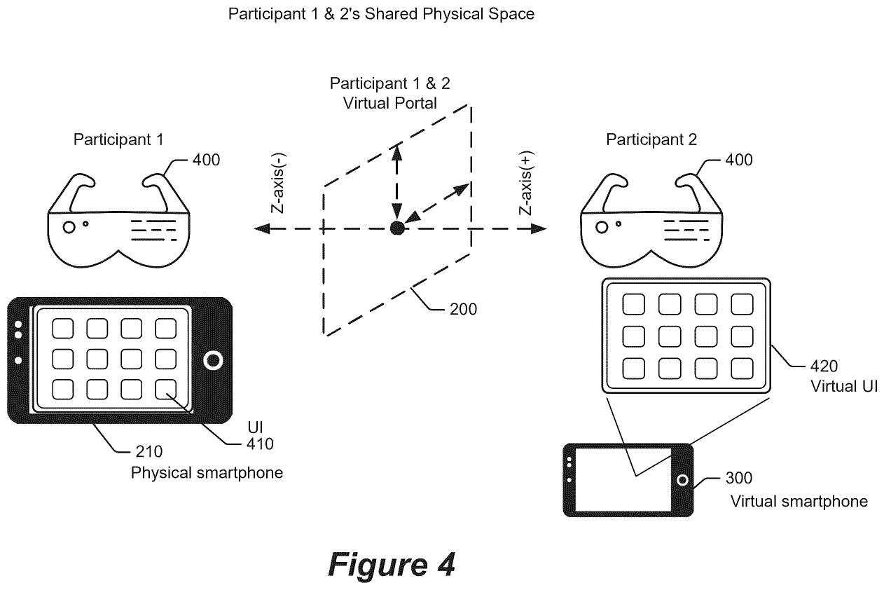

FIG. 4 illustrates an example virtual portal with a virtual user interface (UI) 420 displaying the content of the UI 410 of a physical smartphone 210, in accordance with some embodiments of the present disclosure.

The user interface 410 may have graphical objects with which a participant may interact. The virtual user interface 420 is a virtual representation of the user interface 410 of the physical smartphone 210. The virtual user interface 420 is visible through XR rendering devices such as the XR headset 400. As explained above, graphical objects may be icons or any graphical object which the participant is able to virtually press or otherwise interact. The virtual user interface 420 may be projected or displayed spaced apart from the virtual smartphone 300, such as illustrated in FIG. 4. The virtual user interface 420 may be the same shape and size as the user interface 410 on the physical smartphone 210, or may be scaled to a different size and/or have a different shape compared to the user interface 410 on the physical smartphone 210. The virtual user interface 420 may have a different layout than the user interface 410 of the physical smartphone 210.

Often an object pushed through a virtual portal is owned by the participant (first) pushing it through the virtual portal, and then whatever digital states and attributes associated with the physical electronic device are inherently owned by the first participant. In this scenario, the first participant may have defined or provided access rules for controlling what operational function(s) of the electronic device can be controlled by a second participant, and control what is displayed or can be interacted with on the virtual user interface displayed in the XR environment for the second participant. The access rules may be adapted based on a relationship between the first and second participants, e.g., a defined trust relationship being satisfied. As explained above, operational functions and/or interactions that are not allowed for the second participant may be grayed-out or made non-visible in the virtual user interface, and/or interaction by the second participant with a grayed-out area may trigger a request to the first participant to allow increased access by the second participant with the physical electronic device.

There are other scenarios where the second participant may own or have sufficient access privileges to the physical electronic device. In these scenarios, the second participant may interact with the virtual user interface to enable or prohibit access to certain operational functions of the physical electronic device for access by the first participant. For example, the second participant may interact with the virtual user interface, e.g., type in an unlock code, to unlock the user interface screen of the physical electronic device for access by the first participant.

Accordingly, in some embodiments, the operations determine that the second participant has interacted with the virtual user interface of the electronic device to unlock the operational function of the physical electronic device 210. The operations communicating a message to the physical electronic device 210 indicating the physical electronic device 210 is to unlock the operational function.

In some embodiments, the operational function of the previous embodiments include one of an unlock function to allow all functionality of the physical electronic device 210 to be accessible to the first participant and a defined set of function access privileges to restrict access by the first participant to operational functions of the physical electronic device 210 allowed by the defined set of function access privileges.

In some embodiments, the operations communicate another message to the physical electronic device 210 indicating the physical electronic device 210 is to lock the operational function responsive to the physical electronic device 210 no longer remaining in the virtual portal.

The operations may include to determine ownership of the physical electronic device when rendering the virtual electronic device, e.g., such as whether the first participant pushing the physical electronic device into the virtual portal is the owner or whether the second participant viewing the virtual electronic device is the owner of the physical electronic device. In an illustrative example, Participant 1 pushes a physical smartphone owned by Participant 2 through the virtual portal. Participant 2 interacts with a virtual user interface associated with the rendered virtual phone to enter a screen-unlock code, which is passed by the XR rendering device (XR server) to the physical smartphone where it is passed to the OS to unlock the screen user interface of the smartphone. Depending upon an access rule, the physical smartphone may remain unlocked while the physical smartphone remains in the virtual portal, and Participant 1 may be able to access all or defined UI elements allowed by the access rule. Further depending upon the access rule, the XR rendering device (XR server) may respond to Participant 1 removing the physical smartphone from the virtual portal by sending a message to the physical smartphone that triggers the physical smartphone to re-lock the user interface.

The access rule may contain restrictions on what content and/or application(s) can be accessed on the physical electronic device and/or can be rendered for viewing in the immersive XR environment.

If the pushing first participant is not the owner of physical electronic device and the receiving second participant is the owner of physical electronic device, then access rules are retrievable from a managing node or XR rendering device to physical electronic device to be rendered for second participant post the physical electronic device being passed through or into the virtual portal. The access rule may or may not contain restrictions on what content and/or application(s) is accessible by second participant.

The operations also include associating UI functionality to the digital electronic device according to the second participant and virtual electronic device access rules, such as enabling certain touch areas, icons, or function buttons.

The operations also include terminating access to digital representation of the physical object for second participant upon determining the physical object is retracted (<trigger threshold) by first participant out of the virtual portal. For example, in a scenario where the first participant has pushed a physical phone owned by the second participant through the virtual portal, the first participant can retract the second owner's physical phone out of the virtual portal. A lock command communicated from XR server to physical phone, where it is passed to operating system and triggers locking of the physical phone to prevent further operation by the first participant. The phone may be returned to its prior operational state.

In some embodiments, the operations also include to receive a message from the electronic device indicating what content is displayed on the electronic device. The operations further include to generate the virtual user interface to contain content that is based on what content is indicated by the message as being displayed on the electronic device.

In some of these embodiments, the message indicates at least one of:
a listing of icons for display in the virtual user interface;
a listing of menu items for display in the virtual user interface;
a screen shot of content displayed on the electronic device for display in the virtual user interface; and
a live screen mirroring between what is displayed on the electronic device and what is to be displayed in the virtual user interface.

Some embodiments are directed to enable multiple recipient users to interact with a single physical electronic device. For example, a first participant pushes the physical electronic object through the virtual portal, and because there are more than one recipient participant the XR rendering device evaluates and applies per-recipient based interaction rules. For example, one trusted participant may obtain extensive access to interact with the virtual user interface and control corresponding operational function(s) of the physical electronic device, whereas a less trusted other participant may have more limited access.

Some embodiments are directed to what trigger activation and associated access to the virtual electronic device digital representation of the physical object activation and corresponding deactivation thereof.

Activation may be triggered when a defined amount of the physical electronic device has entered the virtual portal, and the deactivation may be triggered by removal of another defined amount of the physical electronic device from the virtual portal.

### Example XR Rendering Device Configuration.

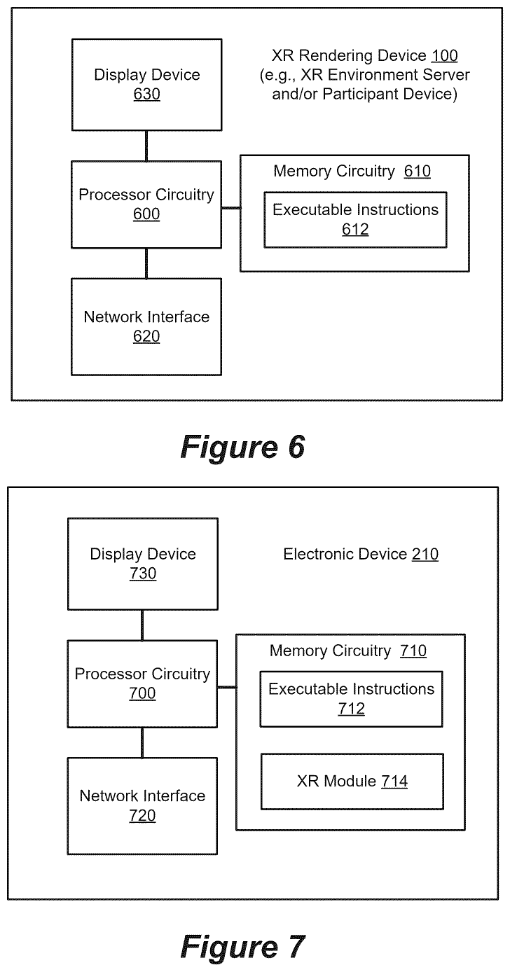

FIG. 6 is a block diagram of components of an XR rendering device 100 that are configured to operate in accordance with some embodiments of the present disclosure. The XR rendering device 100 can include processing circuitry, at least one network interface 620 (network interface), and a display device 630. The processing circuitry may include at least one processor circuit 600 (processor), at least one memory 610 (memory). The processor 600 is operationally connected to these various components. The memory 610 stores executable instructions 612 that are executed by the processor 600 to perform operations. The processor 600 may include one or more data processing circuits, such as a general purpose and/or special purpose processor (e.g., microprocessor and/or digital signal processor), which may be collocated or distributed across one or more data networks. The processor 600 is configured to execute the instructions 612 in the memory 610, described below as a computer readable medium, to perform some or all of the operations and methods for one or more of the embodiments disclosed herein for an XR rendering device. As explained above, the XR rendering device may be separate from and communicatively connected to the participant devices or may be at least partially integrated within one or more of the participant devices.

FIG. 7 is a block diagram of components of an electronic device 210 that are configured to operate in accordance with some embodiments of the present disclosure. The electronic device 210 can include processing circuitry, at least one network interface 720 (network interface), and a display device 730. The processing circuitry may include at least one processor circuit 700 (processor), at least one memory 710 (memory). The processor 700 is operationally connected to these various components. The memory 710 stores executable instructions 712 and an XR module 714 that are executed by the processor 700 to perform operations. The processor 700 may include one or more data processing circuits, such as a general purpose and/or special purpose processor (e.g., microprocessor and/or digital signal processor), which may be collocated or distributed across one or more data networks. The processor 700 is configured to execute the instructions 712 and XR module 714 in the memory 710, described below as a computer readable medium, to perform some or all of the operations and methods for one or more of the embodiments disclosed herein for an electronic device.

### Further Definitions and Embodiments

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the appended examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the following examples of embodiments and their equivalents, and shall not be restricted or limited by the foregoing detailed description.

1. An extended reality, XR, rendering device for rendering an immersive XR environment on a display device for viewing by a second participant in the immersive XR environment, the XR rendering device comprising:
at least one processor; and
at least one memory storing instructions executable by the at least one processor to perform operations to:
define a virtual portal at a location in physical space of a first participant;
track a location of a physical electronic device relative to the location of the entrance boundary;
responsive to determining the physical electronic device has entered the virtual portal, render a virtual electronic device representation in the immersive XR environment of at least a portion of the physical electronic device, wherein the rendering of the virtual electronic device comprises a virtual user interface that the second participant can interact with in the immersive XR environment;
identify a characteristic of an interaction of the second participant with the virtual user interface of the virtual electronic device; and
communicate with the physical electronic device to control an operational function of the physical electronic device based on the identified characteristic of the interaction.

2. The XR rendering device of claim 1, wherein the virtual user interface is rendered to display to the second participant a first set of user selectable items that corresponds to a second set of user selectable items that are displayed on a display of the physical electronic device, and the identified characteristic indicates one of the user selectable items in the first set that has been selected by the second participant.

3. The XR rendering device of claim 2, wherein the communication with the physical electronic device identifies the one of the user selectable items in the first set to trigger control of the operational function of the physical electronic device that is associated with one of the user selectable items in the second set that corresponds to the one of the user selectable items in the first set.

4. The XR rendering device of claim 1, wherein the rendering of the virtual user interface comprises an arrangement of graphical objects that are selectable by the second participant in the immersive XR environment and/or arrangement of menu items that are selectable by the second participant in the immersive XR environment.

5. The XR rendering device of claim 1, wherein the operations further comprise to:
control what interaction the second participant is permitted to have with the virtual user interface of the virtual electronic device based on a security mechanism.

6. The XR rendering device of claim 5, wherein the security mechanism defines functions of the physical electronic device the second participant is allowed to control through interactions by the second participant with the virtual user interface.

7. The XR rendering device of claim 5, wherein:
the security mechanism defines which items of the virtual user interface are selectable by the second participant in the immersive XR environment.

8. The XR rendering device of claim 7, wherein the operations further comprise to:
render the virtual user interface to display items that the security mechanism defines as being selectable by the second participant with a different visual indication than other items that the security mechanism defines as being not selectable by the second participant or to not display items that the security mechanism defines as being not-selectable by the second participant.

9. The XR rendering device of claim 5, wherein the operations further comprise to determine the security mechanism based on at least one of:
a characteristic of the operational function of the electronic device attempted to be controlled by the second participant;
an identifier of the second participant;
a proof of possession of a digital token or cryptographic key of the second participant a location of the first participant;
a location of the second participant;
a time of day or day of week;
a set of capabilities requested from the interaction of the second participant a characteristic of the location of the first participant; and
a characteristic of the location of the second participant.

10. The XR rendering device of claim 1, wherein the operations further comprise to:
responsive to the physical electronic device being removed from the virtual portal, restore the physical electronic device to an operational state existing prior to when the physical electronic device entered the virtual portal.

11. The XR rendering device of claim 10, wherein the operations further comprise to:
responsive to determining the physical electronic device has entered the virtual portal, backup content of a portion of the at least one memory; and
based on the physical electronic device being removed from the virtual portal, restore the portion of the at least one memory based on the backup.

12. The XR rendering device of claim 1, wherein the operations further comprise to:
while the physical electronic device remains in the virtual portal, generate a queue containing a sequence of identified characteristics of interactions of the second participant with the virtual user interface of the virtual electronic device; and
responsive to the physical electronic device being removed from the virtual portal, communicate the sequence of identified characteristics of the interactions contained in the queue to the physical electronic device to control corresponding operational functions of the physical electronic device.

13. The XR rendering device of claim 1, wherein the operations further comprise to:
responsive to the physical electronic device being removed from the virtual portal, terminate rendering of the virtual electronic device representation in the immersive XR environment, including terminating the rendering of the virtual user interface.

14. The XR rendering device of claim 1, wherein the operations further comprise to:
determine that the second participant has interacted with the virtual user interface of the electronic device to unlock the operational function of the physical electronic device; and
communicating a message to the physical electronic device indicating the physical electronic device is to unlock the operational function.

15. The XR rendering device of claim 14, wherein the operational function comprises one of:
a unlock function to allow all functionality of the physical electronic device to be accessible to the first participant; and
a defined set of function access privileges to restrict access by the first participant to operational functions of the physical electronic device allowed by the defined set of function access privileges.

16. The XR rendering device of claim 14, wherein the operations further comprise to:
responsive to the physical electronic device no longer remaining in the virtual portal, communicate another message to the physical electronic device indicating the physical electronic device is to lock the operational function.

17. The XR rendering device of claim 1, wherein the operations further comprise to:
receive a message from the electronic device indicating what content is displayed on the electronic device; and
generate the virtual user interface to contain content that is based on what content is indicated by the message as being displayed on the electronic device.

18. The XR rendering device of claim 17, wherein the message indicates at least one of:
a listing of icons for display in the virtual user interface;
a listing of menu items for display in the virtual user interface;
a screen shot of content displayed on the electronic device for display in the virtual user interface; and
a live screen mirroring between what is displayed on the electronic device and what is to be displayed in the virtual user interface.

19. A method performed by an extended reality, XR, rendering device for rendering an immersive XR environment on a display device for viewing by a second participant in the immersive XR environment, the method comprising:
defining a virtual portal at a location in physical space of a first participant;
tracking a location of a physical electronic device relative to the location of the entrance boundary;
responsive to determining the physical electronic device has entered the virtual portal, rendering a virtual electronic device representation in the immersive XR environment of at least a portion of the physical electronic device, wherein the rendering of the virtual electronic device comprises a virtual user interface that the second participant can interact with in the immersive XR environment;
identifying a characteristic of an interaction of the second participant with the virtual user interface of the virtual electronic device; and
communicating with the physical electronic device to control an operational function of the physical electronic device based on the identified characteristic of the interaction.

20. A computer program product comprising a non-transitory computer readable medium storing instructions executable by at least one processor of extended reality, XR, rendering device rendering an immersive XR environment on a display device for viewing by a second participant in the immersive XR environment, the instructions executed by the at least one processor perform operations comprising:
defining a virtual portal at a location in physical space of a first participant;
tracking a location of a physical electronic device relative to the location of the entrance boundary;
responsive to determining the physical electronic device has entered the virtual portal, rendering a virtual electronic device representation in the immersive XR environment of at least a portion of the physical electronic device, wherein the rendering of the virtual electronic device comprises a virtual user interface that the second participant can interact with in the immersive XR environment;
identifying a characteristic of an interaction of the second participant with the virtual user interface of the virtual electronic device; and
communicating with the physical electronic device to control an operational function of the physical electronic device based on the identified characteristic of the interaction.
